(19) United States
(12) Patent Application Publication
(10) Pub. No.: US 2017/0293891 A1
(43) Pub. Date: Oct. 12, 2017

(54) GRAPHICAL OUTPUT OF CHARACTERISTICS OF PERSON

(71) Applicant: LinkedIn Corporation, Mountain View, CA (US)

(72) Inventors: Mehul Kamlesh Rathod, Fremont, CA (US); Utkarsh Kishor Contractor, Fremont, CA (US)

(21) Appl. No.: 15/096,919

(22) Filed: Apr. 12, 2016

(51) Int. Cl. G06Q 10/10; G06F 17/30

(52) U.S. Cl. CPC G06Q 10/1053; G06F 17/30424; G06Q 50/01

(57) ABSTRACT

Aspects of the present disclosure relate to generating a graphical output of characteristics of a person. A server accesses information about a person, the information comprising one or more of: a public social networking service profile of the person, information submitted by the person, an assessment of the person, and data published by the person. The server determines, based on the accessed information, one or more characteristics of the person. The server provides a graphical output related to the one or more characteristics.

### TECHNICAL FIELD

The subject matter disclosed herein generally relates to generating graphical outputs and data processing. In particular, example embodiments may relate to generating a graphical output of characteristics of a person.

### BACKGROUND

Employees bring diverse characteristics—including hard skills, soft skills, relationships, specialized knowledge, etc.—to companies that employ them. When an employee departs from a company, those characteristics leave with the employee. The company may desire to replace the employee with a new hire. However, determining exactly which characteristics the new hire needs to have to effectively replace the departing employee may be challenging. As the foregoing illustrates, approaches for determining employee characteristics may be desirable.

### SUMMARY

In one aspect, the disclosed subject matter can be embodied in a method. The method includes accessing, by one or more processors, information about a person, the information comprising one or more of: a public social networking service profile of the person, information submitted by the person, an assessment of the person, and data published by the person. The method includes determining, based on the accessed information, one or more characteristics of the person by mining the accessed information for indicators of a specific characteristic from a set of characteristics and determining that the person has or lacks the specific characteristic based on the mined indicators. The method includes providing a graphical output related to the one or more characteristics.

In one aspect, the disclosed subject matter can be embodied in a non-transitory machine-readable medium including instructions. The instructions include code for accessing information about a person, the information comprising one or more of: a public social networking service profile of the person, information submitted by the person, an assessment of the person, and data published by the person. The instructions include code for determining, based on the accessed information, one or more characteristics of the person by mining the accessed information for indicators of a specific characteristic from a set of characteristics and determining that the person has or lacks the specific characteristic based on the mined indicators. The instructions include code for providing a graphical output related to the one or more characteristics.

In one aspect, the disclosed subject matter can be embodied in a system. The system includes one or more processors and a memory. The memory includes instructions. The instructions include code for accessing information about a person, the information comprising one or more of: a public social networking service profile of the person, information submitted by the person, an assessment of the person, and data published by the person. The instructions include code for determining, based on the accessed information, one or more characteristics of the person by mining the accessed information for indicators of a specific characteristic from a set of characteristics and determining that the person has or lacks the specific characteristic based on the mined indicators. The instructions include code for providing a graphical output related to the one or more characteristics.

### BRIEF DESCRIPTION OF THE DRAWINGS

Various ones of the appended drawings merely illustrate example embodiments of the present inventive subject matter and cannot be considered as limiting its scope.

FIG. 1 is a diagram of an example professional graph for a team in a company.

FIG. 2 is a diagram of an example graphical display of characteristics of a person.

FIG. 3 is a diagram of an example system in which a graphical display of characteristics of a person may be generated.

FIG. 4 is a block diagram of an example of the server of FIG. 3.

FIG. 5 is a flowchart illustrating a method for generating a graphical display of characteristics of a person.

FIG. 6 conceptually illustrates an example electronic system with which some implementations of the subject technology can be implemented.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

As noted above, employees bring diverse characteristics—including hard skills, soft skills, relationships, specialized knowledge, etc.—to companies that employ them. When an employee departs from a company, those characteristics leave with the employee. The company may desire to replace the employee with a new hire. However, determining exactly which characteristics the new hire needs to have to effectively replace the departing employee may be challenging. Oftentimes, companies have difficulty defining and articulating exactly which characteristics they are seeking in a new employee and advertise positions by listing only the job title (e.g., senior software engineer) and hard skills (e.g., programming in Java) known to be associated with the advertised position.

In some aspects, the subject technology provides approaches for determining characteristics of a person and displaying the determined characteristics in a graphical output. The subject technology relies upon publicly available data and data available internally within a company, such as a public social networking profile, internal or external reviews, and internal or external recommendations, to determine characteristics of a departing employee (or any other person). The departing employee's manager or the human resources department may then use these determined characteristics to seek new hires, for example, while creating an advertisement for the job opening or while interviewing candidates. According to some aspects, public information within a professional/social networking service or information stored at a job placement agency may be mined to identify potential target candidates who have characteristics similar to those of the departing employee.

FIG. 1 is a diagram of an example professional graph 100 for a team in a company. The professional graph 100 includes a manager M₁ 160 who manages employees E₁ 110, E₂ 120, E₃ 130, E₄ 140, and E₅ 150. The employee E₁ 110, who may be departing from the team or the company, is shown as having characteristics C₁ 111, C₂ 112, C₃ 113, C₄ 114, and C₅ 115. The characteristics C₁ 111, C₂ 112, C₃ 113, C₄ 114, and C₅ 115 include hard skills, soft skills, relationships, specialized knowledge, etc. In one example, C₁ 111, C₂ 112, and C₃ 113 represent hard skills and C₄ 114, and C₅ 115 represent soft skills of the employee E₁ 110.

As used herein, the terms “hard skill,” “soft skill,” and “relationship” encompass their plain and ordinary meanings. Hard skills include technical skills, directly teachable skills, or similar easily quantifiable skills. Examples of hard skills include proficiency in a foreign language, proficiency in a computer programming language, a degree or certificate, typing speed, machine operation, and the like. Soft skills, also known as “people skills” or “interpersonal skills” are skills that are harder to quantify. Examples of soft skills include teamwork, communication, leadership, flexibility, patience, persuasion, time management, and the like. Relationships include relationships with client(s), relationships with vendor(s), relationships with collaborator(s), relationships with other employee(s), and the like Characteristics other than hard skills, soft skills, and relationships are sometimes relevant. For example, specialized knowledge (e.g., knowledge about the operation of social networking software) is relevant in some positions (e.g., intellectual property attorney drafting patents for a professional/social networking service). In another example, a company that uses its hiking club to maintain camaraderie among employees may value employees whose hobbies include hiking. Alternatively, the company may seek employees with other hobbies to increase diversity.

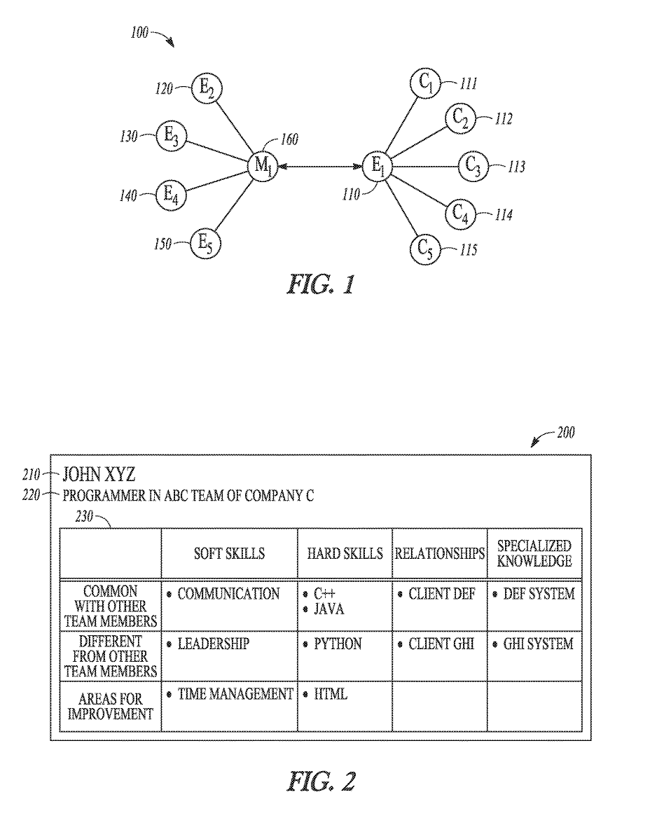

FIG. 2 is a diagram of an example graphical display 200 of characteristics of a person. The graphical display 200 is presented, for example, within a window of a display unit of a computing device or within a printout generated from such a window. As shown, the graphical display 200 includes the person's name 210, the person's job title 220, and a characteristics table 230. The name 210 includes a first and last name (“John Xyz”). The job title 220 includes a position title (“Programmer”), a team name (“ABC Team”), and a company name (“Company C”).

The characteristics table 230 includes columns for “soft skills,” “hard skills,” “relationships,” and “specialized knowledge.” The characteristics table 230 includes rows for characteristics that are “common with other team members” and “different from other team members,” The characteristics table 230 also includes a row for “areas for improvement,” or characteristics that the person could improve to improve his/her job prospects at his/her company or a similar company. In some cases, a characteristic is considered “different from other team members,” if less than a threshold proportion (e.g., 30%) of team members have the characteristic, A characteristic is considered “common with other team member” if at least the threshold proportion of team member have the characteristic.

The “areas for improvement” are determined based on reviews or recommendations of the person. The reviews or recommendations can come from other team members or from any member of the social networking service. For example, as shown in FIG. 2, John Xyz's areas for improvement include “time management” and “hypertext markup language (HTML).” In some cases, the areas for improvement are determined based on information stored within a professional/social networking service. For example, if other members of ABC Team have a skill (e.g., HTML, programming) that John Xyz does not have, John Xyz may benefit from improving this skill.

As shown in FIG. 2, characteristics that John Xyz has in common with other ABC team members include “communication,” “C++,” “Java,” “relationship with Client DEF,” and “specialized knowledge of DEF system.” If John Xyz were to leave ABC team of Company C, ABC team may seek a replacement employee who has these characteristics. As further shown in FIG. 2, characteristics of John Xyz that are different from characteristics of other team members of ABC team include “leadership,” “Python,” “relationship with Client GHI,” and “specialized knowledge of GHI system.” Upon John Xyz's departure from ABC team, ABC team may seek a new employee having these characteristics, especially if ABC team benefits from leadership or is responsible for managing and maintaining the relationship with Client GHI or for Python programming. A manager or human resources director reviewing the graphical display 200 may determine that, upon the departure of John Xyz, Company C may lose Client GHI unless another person with a relationship with that client and specialized knowledge of GHI system is found to replace John Xyz. This information may be relevant in searching for John Xyz's replacement.

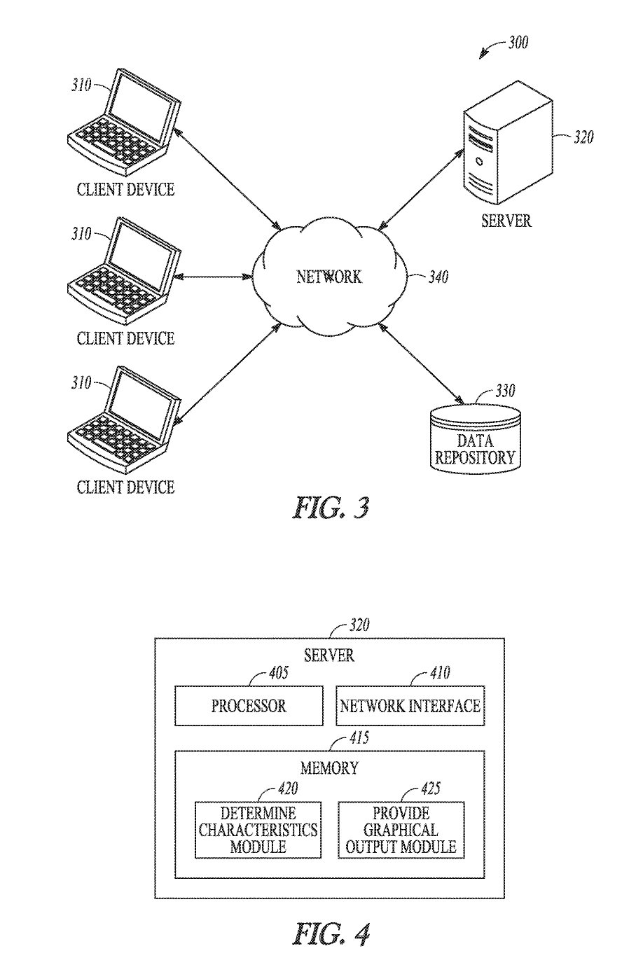

FIG. 3 is a diagram of an example system 300 in which a graphical display of characteristics of a person (e.g., graphical display 200) may be generated. As shown, the system 300 includes client device(s) 310, a server 320, and a data repository 330 connected to one another via a network 340. The network 340 may include one or more of the Internet, an intranet, a local area network (LAN), a wide area network (WAN), a cellular network, a WiFi network, a virtual private network (VPN), a public network, a wired network, a wireless network, etc.

The client device(s) 310 may include one or more of a laptop computer, a desktop computer, a mobile phone, a tablet computer, a personal digital assistant (PDA), a digital music player, a smart watch, and the like. The client device 310 may include an application (or multiple applications), such as a web browser or a special-purpose application, for communicating with the server 320 and the data repository 330. Using the application, a user of the client device 310 accesses the graphical display 200, for example, within a window of a web browser or within a window of a special-purpose application. While three client devices 310 are illustrated in FIG. 3, the subject technology may be implemented with any number of client device(s) 310.

The server 320 stores data or instructions. The server 320 is programmed to determine characteristics of a person and provide the graphical display 200 of the determined characteristics to the client device 310 for display thereat. More details of the operation of the server 320 are provided in conjunction with FIG. 4 and FIG. 5.

The data repository 330 stores data about persons. The data repository 330 includes one or more data repositories. For example, if the subject technology is implemented by a headhunter, the data repository 330 includes a data repository of a professional/social networking service and a data repository of data (e.g., resume data, recommendations, etc.) submitted to the headhunter. If the subject technology is implemented by an employer, the data repository 330 includes a data repository of the professional/social networking service and a data repository of the employer, which stores employee reviews, employee recommendations, listings of projects completed by employees, etc.

The data stored in the data repository 330 includes reviews and recommendations of the persons. The data stored also includes information that each person provided about him/herself and made public within the professional/social networking service. Hard skills of a person may be determined from the data; for example, a person who indicates that he/she is fluent in Spanish or spent several years living or working in a Spanish-speaking country is likely fluent in Spanish. Soft skills are also determined from the data, albeit less directly. For example, someone skilled in “leadership” may indicate that he/she participated in leadership program(s), led team(s) in a business environment, or had a leadership role (e.g., president, founder, etc.) in a social or entertainment group outside a business setting. Someone skilled in “public speaking” may have taken a speech course, attended a speech seminar, or spoken publicly in a business or social setting. Relationships may be indicated within a part of the data repository 330 associated with the professional/social networking service. For example, if two users of the professional/social networking service know one another, they may connect through the professional/social networking service, thereby providing evidence of their relationship. Information about specialized knowledge is also stored in the data repository 330; for example, a person having specialized knowledge about a topic may indicate that he/she read or wrote book(s) or article(s) about the topic or has work experience associated with the topic.

In the implementation of FIG. 3, the system 300 includes a single data repository 330 and a single server 320. However, the subject technology may be implemented with multiple data repositories or multiple servers. Furthermore, as shown in FIG. 3, a single network 340 connects the client device(s) 310, the server 320, and the data repository 330. However, the subject technology may be implemented using multiple networks to connect the machines. Additionally, while the server 320 and the data repository 330 are illustrated as being distinct machines, in some examples, a single machine functions as both the server 320 and the data repository 330.

FIG. 4 is a block diagram of an example of the server 320 of FIG. 3. As shown, the server 320 includes a processor 405, a network interface 410, and a memory 415. The processor 405 executes machine instructions, which may be stored in the memory 415. While a single processor 405 is illustrated, the server 320 may include multiple processors arranged into multiple processing units (e.g., central processing unit (CPU), graphics processing unit (GPU), etc.). The processor 405 includes one or more processors. The network interface 410 allows the server 320 to send and receive data via the network 340. The network interface 410 includes one or more network interface cards (NICs). The memory 415 stores data or instructions. As shown, the memory 415 includes a determine characteristics module 420 and a provide graphical output module 425.

The determine characteristics module 420 is configured to access, in the data repository 330, information about a person. The information includes one or more of a public social networking profile of the person, information submitted by the person, an assessment of the person, and data (e.g., blog post(s), articles, open source code, etc.) published by the person. The determine characteristics module 420 is configured to determine, based on the accessed information, one or more characteristics of the person. The characteristic(s) can be determined by mining the accessed information for indicators of a specific characteristic from a set of characteristics, and determining that the person has or lacks the specific characteristic based on the mined indicators. Operations of the determine characteristics module 420 are described in more detail in conjunction with FIG. 5.

The provide graphical output module 425 is configured to provide a graphical output related to the characteristic(s) of the person determined by the determine characteristics module 420. The graphical output is transmitted from the server 320 to the client device 310 for display at the client device 310. In some cases, the graphical output is transmitted in response to a request for information about the person from the client device 310. For instance, the client device 310 may be operated by a manager or a human resources representative considering the departure of an existing employee or hiring a new candidate for employment.

As used herein, the term “configured” encompasses its plain and ordinary meaning. A module (e.g., module 420 or 425) may be configured to carry out operation(s) by storing code for the operation(s) in memory (e.g., memory 415). Processing hardware (e.g., processor 405) may carry out the operations by accessing the appropriate locations in the memory. Alternatively, the module may be configured to carry out the operation(s) by having the operation(s) hard-wired in the processing hardware.

FIG. 5 is a flowchart illustrating a method 500 for generating a graphical display of characteristics of a person. According to some aspects, the method 500 may be implemented at the server 320. In some cases, the method 500 is implemented in response to a request, from a client device 310, for information about a person. The request is made within a web browser window or within a window of a special-purpose application that accesses the server 320 via the network 340.

The method 500 begins at step 510, where the server 320 accesses information about a person, for example, in the data repository 330. The accessed information, which is stored in the data repository 330, includes a public social networking profile of the person, information (e.g., self-evaluation, resume, sample work product, and the like) submitted by the person, an assessment (e.g., recommendation, review, and the like) of the person, and data (e.g., blog posts, publicly accessible open-source code of a programmer, publicly accessible court or administrative agency filings of an attorney, and the like) published by the person. The data repository 330, in some cases, includes data from a professional/social networking service and data gathered by an employer or recruiting agency. The data repository 330 may include one data repository or multiple data repositories.

At step 520, the server 320 determines characteristic(s) of the person based on the information accessed in the data repository 330. In some cases, the server 320 mines the accessed information for indicators of a specific characteristic from a set of characteristics, and determines that the person has or lacks the specific characteristic based on the mined indicators. The characteristic(s) include one or more of soft skills, hard skills, relationships, and specialized knowledge.

In some cases, hard skills can be explicitly indicated, for example, in the person's resume or social networking profile. For example, the member may enter his or her skills explicitly through the social networking service. In some cases, hard skills can be inferred from the professional/social networking profile. For example, if a person lived in France and worked as a Java programmer for a French company for several years, that person is likely skilled in the French language and in Java programming. In some cases, soft skills can be inferred based on the person's experiences listed in his/her resume, recommendations, reviews, or social networking profile. Language skills are inferred based on employment or residence in a country. Hard skills are inferred based on past employment experience and skills required for the past employment experience. Soft skills are inferred based on business activities or hobbies and the person's role therein. For example, if a person's reviews indicate that the person gave several speeches, and the person attended a speech conference, the person is likely skilled in public speaking. Relationships can be inferred based on connections in the professional/social networking service. In some cases, a relationship with a business or institution is inferred if a person has connections with at least a threshold number (e.g., 5 or 10) of employees of the business. For example, if a person is connected with several employees of ABC Corporation, the person likely has a relationship with ABC Corporation. Specialized knowledge can be inferred from the person's resume, recommendations, reviews, or social networking profile. For example, text in the resume, recommendations, reviews, or social networking profile is analyzed to determine specialized knowledge. For example, a patent attorney whose resume and recommendations indicate that he drafted and prosecuted several patents related to cellular technology is likely to have specialized knowledge about cellular technology.

In some cases, machine learning, for example, natural language processing (NLP), techniques are used to find a person's soft skills from the person's reviews and online postings. In addition, endorsements or recommendations within the social networking service can be used to find hard skills. Using social network connection data, a person's relationships, for example, with clients or vendors, are identified. A strength of a relationship is, in some cases, inferred based on a messages (e.g., email or instant messages) sent between members of the relationship (e.g., number of messages). In addition, machine learning or NLP is, in some examples, applied to internal (e.g., human resources) data to reveal a person's soft skills or hard skills. Furthermore, soft skills and hard skills may be inferred through internal systems, such as git, wiki, docs, project plans, sales force, emails, design documents, awards data. Furthermore, NLP can be applied to determine soft skills and hard skills, for example, someone who is a lead developer or lead quality assurance (QA) person likely has leadership skills. Someone who has one or more sales awards likely has sales skills.

At step 530, the server 320 provides a graphical output related to the determined characteristics. In some cases, the graphical output is transmitted over the network 340 to the client device 310, which requested the information about the person, for display at the client device 310.

In some cases, the server 320 also accesses, in the data repository 330, information about one or more second person(s). The server 320 determines, using the techniques described herein, characteristic(s) of the second person(s) based on the accessed information. The characteristics of the second person(s) can be compared with the characteristics of the original person (of steps 510-520) and a result of the comparison can be provided in the graphical output. For example, as shown in FIG. 2, the person John Xyz is compared to other members of ABC team to determine which of John Xyz's characteristics are similar to and different from the characteristics of the other team members. For example, as shown in FIG. 2, John Xyz shares “communication” skills with his team members, but has “leadership” skills that are different from those of his team members. Based on this information, a manager or human resources representative can deduce that members of ABC team are, in general, good communicators but that John Xyz's leadership skills distinguished him from the other employees, possibly increasing John Xyz's value to ABC team.

In some cases, John Xyz may share skills with a certain proportion (e.g., 50%) of the other members of ABC team. The proportion can be displayed in the graphical output, for example, adjacent to the skill. In other words, the text “C++” may be replaced with “C++ (80%),” indicating that 80% of the other team members are skilled in C++. In other cases, color codes can be used, with different colors representing characteristic(s) of the subject person (John Xyz) that are similar to or different from characteristics of the other team members. In other words, the server 320, in some cases, determines a common set of characteristic(s) between the person and the second person(s) and a set of characteristic(s) that distinguish the person from the second person(s), and identifies the common and distinguishing characteristics) in the graphical display 200.

In some implementations, the server 320 determines, based on the result of comparing the characteristic(s) of the person (John Xyz) with the characteristic(s) of the second person(s) (the other members of ABC team), a set of characteristics for the person (John Xyz) to obtain. These characteristics are presented in the graphical display 200 within the characteristics table 230. For example, if at least a threshold proportion (e.g., 80%) of the members of ABC team have the skills “time management” and “HTML,” and John Xyz lacks these skills, John Xyz may be able to strengthen his resume and increase his value to ABC team (or a similar team at another company) by improving his time management and HTML skills. This determination may be provided in a recommendation to John Xyz, either by the server 320 (e.g., in an automatically generated message transmitted within the professional/social networking service or via email) or by a person reviewing the graphical display 200 at the client device 310. After step 530, the method 500 ends.

Various use cases of the subject technology are possible. In one use case, the person whose information is presented is an employee departing from a company. The graphical display 200 includes a list of characteristics to seek in a replacement for the employee. In another use case, a person seeking to strengthen his/her own resume or credentials may generate the graphical display 200 for him/herself in order to determine which skill(s) or characteristic(s) he/she may need to gain to become more competitive with his/her peers and in which skill(s) or characteristic(s) he/she is already competitive. In yet another use case, a manager could access the graphical display 200 for an employee in generating a performance review for the employee, or a hiring director could access the graphical display 200 for a job candidate in reviewing the application of the job candidate.

In one use case, characteristics of multiple different people, determined using the techniques described herein, are stored at the server 320 or the data repository 330. A recruiter or hiring director may search the people to find a potential candidate to recruit for a new job opening based on the candidate's characteristics. The recruiter or hiring director may then reach out to the candidate directly. In this way, companies with job openings are able to find the most valuable person(s) to fill their needs, and a departing employee may be replaced with a new employee who has similar characteristics to those of the departing employee.

Aspects of the subject technology involve storing information about persons at data repositories or servers, which may belong to a professional/social networking service, a job recruiting service, or the like. Persons whose information is stored may affirmatively consent, via an opt-in process, to having their information stored, and may opt out of having their information stored at any time. If a person opts out, his/her information is removed from the data repositories and the servers. Persons may be periodically reminded (e.g., via electronic messages, such as email, or displays within the professional/social networking service) that their information is stored and given the opportunity to opt out of having their information stored. Information about a given person is not stored without his/her affirmative consent.

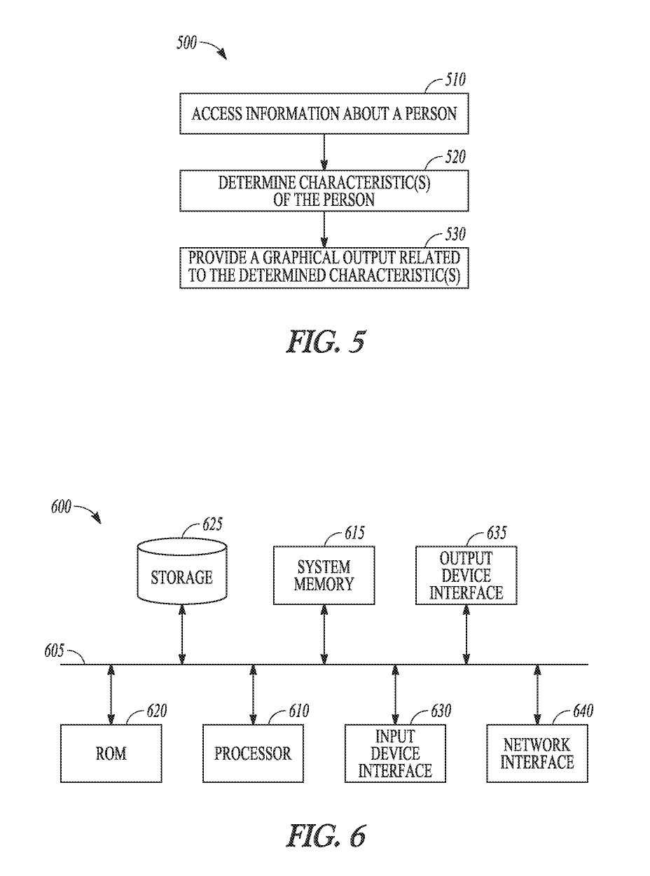

FIG. 6 conceptually illustrates an electronic system 600 with which some implementations of the subject technology are implemented. For example, one or more of the client device 310, the server 320, or the data repository 330 may be implemented using the arrangement of the electronic system 600. The electronic system 600 can be a computer (e.g., a mobile phone or PDA) or any other sort of electronic device. Such an electronic system 600 includes various types of computer-readable media and interfaces for various other types of computer-readable media. The electronic system 600 includes a bus 605, processor(s) 610, a system memory 615, a read-only memory (ROM) 620, a permanent storage device 625, an input device interface 630, an output device interface 635, and a network interface 640.

The bus 605 collectively represents all system, peripheral, and chipset buses that communicatively connect the numerous internal devices of the electronic system 600. For instance, the bus 605 communicatively connects the processor(s) 610 with the ROM 620, the system memory 615, and the permanent storage device 625.

From these various memory units, the processor(s) 610 retrieves instructions to execute and data to process in order to execute the processes of the subject technology. The processor(s) 610 can include a single processor or a multi-core processor in different implementations.

The ROM 620 stores static data and instructions that are needed by the processor(s) 610 and other modules of the electronic system 600. The permanent storage device 625, on the other hand, is a read-and-write memory device. This device is a non-volatile memory unit that stores instructions and data even when the electronic system 600 is off. Some implementations of the subject technology use a mass-storage device (for example, a magnetic or optical disk and its corresponding disk drive) as the permanent storage device 625. Other implementations use a removable storage device (for example, a floppy disk or flash drive, and its corresponding disk drive) as the permanent storage device 625.

Like the permanent storage device 625, the system memory 615 is a read-and-write memory device. However, unlike the permanent storage device 625, the system memory 615 is a volatile read-and-write memory, such as a random access memory (RAM). The system memory 615 stores some of the instructions and data that the processor(s) 610 needs at runtime. In some implementations, the processes of the subject technology are stored in the system memory 615, the permanent storage device 625, or the ROM 620. For example, the various memory units include instructions for generating a graphical output of characteristics of a person, in accordance with some implementations. From these various memory units, the processor(s) 610 retrieves instructions to execute and data to process in order to execute the processes of some implementations.

The bus 605 also connects to the input and output device interfaces 630 and 635. The input device interface 630 enables the user to communicate information and select commands to the electronic system 600. Input devices used with the input device interface 630 include, for example, alphanumeric keyboards and pointing devices (also called “cursor control devices”). The output device interface 635 enables, for example, the display of images generated by the electronic system 600. Output devices used with the output device interface 635 include, for example, printers and display devices, for example cathode ray tubes (CRTs) or liquid crystal displays (LCDs). Some implementations include devices (for example, a touch screen) that function as both input and output devices.

Finally, as shown in FIG. 6, the bus 605 also couples the electronic system 600 to a network (not shown) through the network interface 640. In this manner, the electronic system 600 can be a part of a network of computers (for example, a LAN, a WAN, or an Intranet) or a network of networks (for example, the Internet). Any or all components of the electronic system 600 can be used in conjunction with the subject technology.

The above-described features and applications can be implemented as software processes that are specified as a set of instructions recorded on a computer-readable storage medium (also referred to as a computer-readable medium). When these instructions are executed by one or more processor(s) (which may include, for example, one or more processors, cores of processors, or other processing units), they cause the processor(s) to perform the actions indicated in the instructions. Examples of computer-readable media include, but are not limited to, compact disk read-only memories (CD-ROMs), flash drives, RAM chips, hard drives, erasable programmable read-only memories (EPROMs), and the like. The computer-readable media do not include carrier waves and electronic signals passing wirelessly or over wired connections.

In this specification, the term “software” is meant to include firmware residing in RUM or applications stored in magnetic storage or flash storage (for example, a solid-state drive) that can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described herein is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages and declarative or procedural languages, and it can be deployed in any form, including as a standalone program or as a module, component, subroutine, Object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The functions described above can be implemented in digital electronic circuitry, or in computer software, firmware, or hardware. The techniques can be implemented using one or more computer program products. Programmable processors and computers can be included in or packaged as mobile devices. The processes and logic flows can be performed by one or more programmable processors and by one or more machine components implementing programmable logic circuitry. General- and special-purpose computing devices and storage devices can be interconnected through communication networks.

Some implementations include electronic components, for example microprocessors, storage, and memory, that store computer program instructions in a machine-readable or computer-readable medium (alternatively referred to as computer-readable storage media, machine-readable media, non-transitory machine-readable media, or machine-readable storage media). Some examples of such computer-readable media include RAM, ROM, CD-ROM, recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., secure digital (SD) cards, mini-SD cards, micro-SD cards, etc.), magnetic or solid state hard drives, read-only and recordable Blu-Ray® discs, ultra-density optical discs, any other optical or magnetic media, and floppy disks. The computer-readable media can store a computer program that is executable by at least one processor and includes sets of instructions for performing various operations. Examples of computer programs or computer code include machine code (for example, produced by a compiler) and files including higher-level code that are executed by a computer, an electronic component, or a microprocessor using an interpreter.

While the above discussion primarily refers to microprocessors or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification and any claims of this application, the terms “computer,” “server,” “processor,” and “memory” all refer to electronic or other technological devices. These terms exclude people or groups of people. For the purposes of the specification, the terms “display” or “displaying” mean displaying on an electronic device. As used in this specification and any claims of this application, the terms “computer-readable medium” and “computer-readable media” are entirely restricted to tangible, physical objects that store information in a form that is readable by a computer. These terms exclude any wireless signals, wired download signals, and other ephemeral signals.

To provide for interaction with a user, implementations of the subject matter described in this specification can be implemented on a computer having a display device, e.g., a CRT or LCD monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user (for example, by sending web pages to a web browser on a user's client device in response to requests received from the web browser).

The subject matter described in this specification can be implemented in a computing system that includes a back-end component, e.g., a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a LAN and a WAN, an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., as a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged. In some implementations, not all of the illustrated steps are preformed or only a portion of the illustrated steps are performed. Some of the steps may be performed simultaneously. For example, in certain circumstances, multitasking and parallel processing may be implemented. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but are to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect,” does not imply that the aspect is essential to the subject technology or that the aspect applies to all configurations of the subject technology. A disclosure relating to an aspect may apply to all configurations, or one or more configurations. A phrase, for example, an “aspect,” may refer to one or more aspects, and vice versa. A phrase, for example, a “configuration,” does not imply that such a configuration is essential to the subject technology or that such a configuration applies to all configurations of the subject technology. A disclosure relating to a configuration may apply to all configurations, or one or more configurations. A phrase, for example, a “configuration,” may refer to one or more configurations, and vice versa.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the disclosed subject matter has been described with reference to specific example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

In this document, the terms “a” or “an” are used, as is common in patent documents, to include one or more than one, independent of any other instances or usages of “at least one” or “one or more.” In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” and so forth are used merely as labels, and are not intended to impose numerical requirements on their objects.

What is claimed is:

1. A method comprising:
accessing, by one or more processors, information about a person, the information comprising one or more of: a public social networking service profile of the person, information submitted by the person, an assessment of the person, and data published by the person;
determining, based on the accessed information, one or more characteristics of the person by:
mining the accessed information for indicators of a specific characteristic from a set of characteristics, and
determining that the person has or lacks the specific characteristic based on the mined indicators; and
providing a graphical output related to the one or more characteristics, wherein the characteristics comprise one or more of: hard skills, soft skills, relationships, and specialized knowledge.

2. The method of claim 1, wherein the information submitted by the person comprises a resume or a sample work product.

3. The method of claim 1, wherein the assessment of the person comprises a review or a recommendation of the person.

4. The method of claim 1, wherein the person is an employee departing from a company, and wherein the graphical output comprises a list of characteristics for a replacement for the employee.

5. The method of claim 1, further comprising:
accessing, by the one or more processors, information about a second person;
determining, based on the accessed information about the second person, one or more characteristics of the second person; and
comparing the one or more characteristics of the person with the one or more characteristics of the second person.

6. The method of claim 5, further comprising:
determining, based on a result of comparing the one or more characteristics of the person with the one or more characteristics of the second person, a set of characteristics for the person to obtain,
wherein the graphical output comprises a representation of the set of characteristics for the person to obtain.

7. The method of claim 5, further comprising:
determining, based on a result of comparing the one or more characteristics of the person with the one or more characteristics of the second person, a common set of characteristics of the person and the second person,
wherein the graphical output comprises a representation of the common set of characteristics.

8. A non-transitory machine-readable medium comprising instructions which, when executed by one or more processors of a machine, cause the machine to perform operations comprising:
accessing information about a person, the information comprising one or more of: a public social networking service profile of the person, information submitted by the person, an assessment of the person, and data published by the person;
determining, based on the accessed information, one or more characteristics of the person by:
mining the accessed information for indicators of a specific characteristic from a set of characteristics, and
determining that the person has or lacks the specific characteristic based on the mined indicators; and
providing a graphical output related to the one or more characteristics, wherein the characteristics comprise one or more of: hard skills, soft skills, relationships, and specialized knowledge.

9. The machine-readable medium of claim 8, wherein the information submitted by the person comprises a resume or a sample work product.

10. The machine-readable medium of claim 8, wherein the assessment of the person comprises a review or a recommendation of the person.

11. The machine-readable medium of claim 8, wherein the person is an employee departing from a company, and wherein the graphical output comprises a list of characteristics for a replacement for the employee.

12. The machine-readable medium of claim 8, the operations further comprising:
accessing, by the one or more processors, information about a second person;
determining, based on the accessed information about the second person, one or more characteristics of the second person; and
comparing the one or more characteristics of the person with the one or more characteristics of the second person.

13. The machine-readable medium of claim 12, the operations further comprising:
determining, based on a result of comparing the one or more characteristics of the person with the one or more characteristics of the second person, a set of characteristics for the person to obtain,
wherein the graphical output comprises a representation of the set of characteristics for the person to obtain.

14. The machine-readable medium of claim 12, the operations further comprising:
determining, based on a result of comparing the one or more characteristics of the person with the one or more characteristics of the second person, a common set of characteristics of the person and the second person,
wherein the graphical output comprises a representation of the common set of characteristics.

15. A system comprising:
one or more processors; and
a memory comprising instructions which, when executed by the one or more processors, cause the one or more processors to perform operations comprising:
accessing information about a person, the information comprising one or more of: a public social networking service profile of the person, information submitted by the person, an assessment of the person, and data published by the person;
determining, based on the accessed information, one or more characteristics of the person by:
mining the accessed information for indicators of a specific characteristic from a set of characteristics, and
determining that the person has or lacks the specific characteristic based on the mined indicators; and
providing a graphical output related to the one or more characteristics, wherein the characteristics comprise one or more of: hard skills, soft skills, relationships, and specialized knowledge.

16. The system of claim 15, wherein the information submitted by the person comprises a resume or a sample work product.

17. The system of claim 15, wherein the assessment of the person comprises a review or a recommendation of the person.

18. The system of claim 15, wherein the person is an employee departing from a company, and wherein the graphical output comprises a list of characteristics for a replacement for the employee.

19. The system of claim 15, the operations further comprising:
accessing, by the one or more processors, information about a second person;
determining, based on the accessed information about the second person, one or more characteristics of the second person; and
comparing the one or more characteristics of the person with the one or more characteristics of the second person.

20. The system of claim 19, the operations further comprising:
determining, based on a result of comparing the one or more characteristics of the person with the one or more characteristics of the second person, a set of characteristics for the person to obtain,
wherein the graphical output comprises a representation of the set of characteristics for the person to obtain.
